(19) United States
(12) Patent Application Publication
(10) Pub. No.: US 2024/0046120 A1
(43) Pub. Date: Feb. 8, 2024

(54) TRAINING METHOD AND PREDICTION METHOD FOR DIAGENETIC PARAMETER PREDICTION MODEL BASED ON ARTIFICIAL INTELLIGENCE ALGORITHM

(71) Applicant: China University of Petroleum-Beijing, Beijing City (CN)

(72) Inventors: Leilei YANG, Beijing City (CN); Keyu LIU, Beijing City (CN); Wei YANG, Beijing City (CN); Hui WANG, Beijing City (CN); Wenhao YANG, Beijing City (CN); Zijie ZHOU, Beijing City (CN); Ke XU, Beijing City (CN); Yinglin CAO, Beijing City (CN); Xiaowei LI, Beijing City (CN); Yi LIU, Beijing City (CN); Dawei WANG, Beijing City (CN); Shu XU, Beijing City (CN); Ziyang SONG, Beijing City (CN)

(73) Assignee: China University of Petroleum-Beijing, Beijing City (CN)

(21) Appl. No.: 18/355,700

(22) Filed: Jul. 20, 2023

(30) Foreign Application Priority Data
Aug. 3, 2022 (CN) 202210925841.8

(51) Int. Cl. G06N 5/022

(52) U.S. Cl. CPC G06N 5/022

(57) ABSTRACT

The present disclosure provides a training method and a prediction method for a diagenetic parameter prediction model based on an artificial intelligence algorithm, which includes: obtaining a plurality of diagenesis samples each including diagenetic condition parameters and an actual diagenetic parameter evolved therefrom; constructing an initial diagenetic parameter prediction model based on the diagenesis samples and a total dimension of the diagenetic condition parameters; and training the initial diagenetic parameter prediction model with the diagenesis samples so as to obtain a trained diagenetic parameter prediction model. The present disclosure can obtain a diagenetic parameter prediction model by training with the existing diagenesis samples, thereby solving problems of large amount of calculation, high uncertainty and large deviations in the prediction of the diagenetic parameters, which leads to a low evaluation accuracy of reservoirs and limits the oil and gas exploration.

### CROSS-REFERENCE TO RELATED APPLICATIONS

This application claims priority to Chinese Patent Application No. 202210925841.8, filed on Aug. 3, 2022, which is hereby incorporated by reference in its entirety.

### FIELD

The present disclosure relates to the technical field of reservoir parameter prediction, and particularly to a training method and a prediction method for a diagenetic parameter prediction model based on an artificial intelligence algorithm.

### BACKGROUND

Diagenesis often occurs in a geological environment within several kilometers underground, and the diagenetic mechanism and the quality evaluation of reservoirs are the key technical bottlenecks faced by the oil and gas exploration and development, while the restoration of the diagenetic evolution process of the reservoirs is the core scientific issue to be solved urgently. With the development of diagenesis researches, the numerical simulation technology appeared in recent years could restore the diagenetic evolution process, and to a certain extent, realize the quantitative evaluation of diagenetic parameters such as a mineral content, an ion concentration, a reservoir porosity and a permeability in the diagenesis. However, the diagenetic time of the reservoirs is up to millions of years and there are hundreds of influencing factors, resulting in large amount of calculation, high uncertainty and strong artificial operability in the simulation of the diagenetic parameters, which leads to a low evaluation precision of reservoirs and limits the oil and gas exploration.

In view of this, the present disclosure aims to provide a training method and a prediction method for a diagenetic parameter prediction model based on an artificial intelligence algorithm.

### SUMMARY

In view of the above problems in the prior art, an objective of the present disclosure is to provide a training method and a prediction method for a diagenetic parameter prediction model based on an artificial intelligence algorithm, so as to solve the problems of high uncertainty, strong artificial factors and low accuracy of a diagenetic simulation in the prior art.

In order to solve the above technical problems, the specific technical solutions of the present disclosure are as follows:

In a first aspect, the present disclosure provides a diagenetic parameter prediction model training method based on an artificial intelligence algorithm, including:
obtaining a plurality of diagenesis samples each including diagenetic condition parameters and an actual diagenetic parameter evolved therefrom;
constructing an initial diagenetic parameter prediction model based on the diagenesis samples and a total dimension of the diagenetic condition parameters; and
training the initial diagenetic parameter prediction model with the diagenesis samples until a loss between diagenetic parameter predict values obtained by the initial diagenetic parameter prediction model and the actual diagenetic parameters is within a preset loss range or the diagenetic parameter predict values reach a preset accuracy, so as to obtain a trained diagenetic parameter prediction model.

Specifically, the diagenetic condition parameters include a diagenesis prediction period, and at least further include one or combinations of an ion concentration, a mineral content, temperature and pressure conditions, an acidity-basicity, and a porosity; the actual diagenetic parameter at least include one or more of the ion concentration, the mineral content, the temperature and pressure conditions, the acidity-basicity and the porosity after an evolution time elapses by the diagenesis prediction period.

Optionally, the ion concentration, the mineral content, the temperature and pressure conditions, the acidity-basicity, and the porosity at least included in the diagenetic condition parameters are measured values obtained at one or more observation moments.

Specifically, before the step of training the initial diagenetic parameter prediction model with the diagenesis samples, the method further includes:
carrying out a feature selection on the diagenetic condition parameters, and removing a parameter with an influence coefficient less than a preset value, among the diagenetic condition parameters.

Further, the step of constructing an initial diagenetic parameter prediction model based on the diagenesis samples and a total dimension of the diagenetic condition parameters includes:
constructing a machine learning model based on the diagenesis samples when the total dimension of the diagenetic condition parameters is less than a preset dimension threshold, and taking the machine learning model as the initial diagenetic parameter prediction model; and
constructing a deep learning network model based on the diagenesis samples when the total dimension of the diagenetic condition parameters is greater than or equal to the preset dimension threshold, and taking the deep learning network model as the initial diagenetic parameter prediction model.

Optionally, before the step of training the initial diagenetic parameter prediction model with the diagenesis samples, the method further comprises:

Classifying the diagenesis samples into a training set and a test set in a preset ratio using a random sampling method or a stratified sampling method; and
normalizing the diagenetic condition parameters in the training set using a following formula:

$${x}_{i}^{′} = \frac{{x}_{i} - {μ}_{i}}{{δ}_{i}} ;$$

where xᵢ denotes a diagenetic condition parameter of an i-th dimension in the training set, xᵢ′ denotes a normalized value of xᵢ, a value range of i is 1 to n, and n is a dimension of the diagenetic condition parameters; μᵢ denotes an average value of the diagenetic condition parameters in the i-th dimension and δᵢ denotes a standard deviation of the diagenetic condition parameters in the i-th dimension.

In a second aspect, the present disclosure further provides a diagenetic parameter prediction method, which applies a diagenetic parameter prediction model obtained using the diagenetic parameter prediction model training method based on the artificial intelligence algorithm according to the above technical solutions, and the prediction method includes:
collecting diagenetic condition parameters; and
inputting the diagenetic condition parameters into the diagenetic parameter prediction model to obtain diagenetic parameters predicted based on the diagenetic condition parameters.

In a third aspect, the present disclosure further provides a diagenetic parameter prediction model training apparatus based on an artificial intelligence algorithm, includes:
an obtainment module configured to obtain a plurality of diagenesis samples each including diagenetic condition parameters and an actual diagenetic parameter evolved therefrom;
a construction module configured to construct an initial diagenetic parameter prediction model based on the diagenesis samples and a total dimension of the diagenetic condition parameters; and
a training module configured to train the initial diagenetic parameter prediction model with the diagenesis samples until a loss between diagenetic parameter predict values obtained by the initial diagenetic parameter prediction model and the actual diagenetic parameters is within a preset loss range or the diagenetic parameter predict values reach a preset accuracy, so as to obtain a trained diagenetic parameter prediction model.

In a fourth aspect, the present disclosure provides a diagenetic parameter prediction apparatus, including:
a collection module configured to collect diagenetic condition parameters; and
a prediction module configured to input the diagenetic condition parameters into the diagenetic parameter prediction model to obtain diagenetic parameters predicted based on the diagenetic condition parameters.

In a fifth aspect, the present disclosure provides a computer device, including a memory, a processor and a computer program stored in the memory and runnable in the processor, and when executing the computer program, the processor implements the diagenetic parameter prediction model training method or the diagenetic parameter prediction method according to the above technical solutions.

By adopting the above technical solutions, the diagenetic parameter prediction model training method, the diagenetic parameter prediction method, and their apparatus according to the present disclosure can obtain a diagenetic parameter prediction model by training with the existing diagenesis samples, and solve the problem that the diagenetic time of the reservoirs is up to millions of years and there are many influencing factors, resulting in large amount of calculation, high uncertainty and large errors of in the simulation and prediction of the diagenetic parameters, which leads to a low evaluation precision of reservoirs and limits the oil and gas exploration.

In order that the above and other objects, features and advantages of the present disclosure can be more readily understood, embodiments of the present disclosure will be described in detail below with reference to the drawings.

### BRIEF DESCRIPTION OF THE DRAWINGS

In order to explain the technical solutions in the embodiments of the present disclosure or in the prior art more clearly, the drawings required for describing the embodiments or the prior art will be briefly introduced as follows. Obviously, the drawings in the following description merely illustrate some embodiments of the present disclosure, and those skilled in the art can derive other drawings from them without paying any creative effort.

FIG. 1 illustrates a schematic diagram of steps of a diagenetic parameter prediction model training method based on an artificial intelligence algorithm according to an embodiment of the present disclosure;

FIG. 2 illustrates a schematic diagram of a comparison between diagenetic parameter predict values and actual diagenetic parameters;

FIG. 3 illustrates a schematic diagram of a structure of a deep learning network model constructed according to an embodiment of the present disclosure;

FIG. 4 illustrates a schematic diagram of a structure of a deep learning network model processed with a dropout method according to an embodiment of the present disclosure;

FIG. 5 illustrates a schematic diagram of steps of a diagenetic parameter prediction method according to an embodiment of the present disclosure;

FIG. 6 illustrates a schematic diagram of a structure of a diagenetic parameter prediction model training apparatus based on an artificial intelligence algorithm according to an embodiment of the present disclosure;

FIG. 7 illustrates a schematic diagram of a structure of a diagenetic parameter prediction apparatus according to an embodiment of the present disclosure;

FIG. 8 illustrates a schematic diagram of a structure of a computer device according to an embodiment of the present disclosure.

### REFERENCE NUMERALS

61: obtainment module;
62: construction module;
63: training module;
71: collection module;
72: prediction module;
802: computer device;
804: processor;
806: memory;
808: driving mechanism;
810: input/output module;
812: input device;
814: output device;
816: representation device;
818: graphical user interface;
820: network interface;
822: communication link;
824: communication bus.

### DETAILED DESCRIPTION

The technical solutions in the embodiments of the present disclosure will be clearly and completely described below with reference to the drawings in the embodiments of the present disclosure. Obviously, those described are only a part, rather than all, of the embodiments of the present disclosure. Based on the embodiments of the present disclosure, any other embodiment obtained by those of ordinary skills in the art without paying any creative effort should fall within the protection scope of the present disclosure.

It should be noted that the terms ‘first’, ‘second’ and the like in the description and the claims of the present disclosure and the foregoing drawings are used to distinguish similar objects and not necessarily to describe a particular order or precedence. It should be understood that data so used can be interchanged under appropriate circumstances so that the embodiments of the present disclosure described here can be implemented in an order other than those illustrated or described here. Furthermore, the terms ‘comprise’, ‘include’, ‘have’ and any variant thereof, are intended to cover non-exclusive inclusions. For example, a process, a method, an apparatus, a product or a device, which includes a series of steps or units, is not necessarily limited to those explicitly listed, but may include other steps or units not expressly listed or inherent to the process, the method, the apparatus, the product, or the device.

Diagenesis refers to a process of transformation from loose sediments into a sedimentary rock under the influence of certain pressure and temperature. The diagenetic time of the reservoirs is up to millions of years and there are hundreds of influencing factors, such that the existing diagenesis digital simulation technology has the problems of large amount of calculation, high uncertainty and large deviations.

In order to solve the above problems, the embodiments of the present disclosure provide a training method and a prediction method for a diagenetic parameter prediction model based on an artificial intelligence algorithm, which can predict diagenetic parameters in diagenesis. FIG. 1 illustrates a schematic diagram of steps of a diagenetic parameter prediction model training method based on an artificial intelligence algorithm according to an embodiment of the present disclosure. Although the present disclosure provides methodical operation steps as illustrated in the embodiments or the flowcharts, more or fewer operation steps may be included based on the conventional or non-inventive labors. The step execution order listed in the embodiments is only one of various step execution orders and does not represent a unique execution order. When an actual system or apparatus product is executed, the steps may be executed orderly or in parallel according to the method illustrated in the embodiments or the drawings. Specifically, as illustrated in FIG. 1, the method may include:

S110: obtaining a plurality of diagenesis samples each comprising diagenetic condition parameters and an actual diagenetic parameter evolved therefrom.

The diagenetic condition parameters include a diagenesis prediction period, and at least further include one or combinations of an ion concentration, a mineral content, temperature and pressure conditions, an acidity-basicity, and a porosity. The diagenetic condition parameters may further include other parameters not listed, such as geological parameters of the reservoir samples, like latitude and longitude, burial depth, etc. The actual diagenetic parameters at least include one or combinations of the ion concentration, the mineral content, the temperature and pressure conditions, the acidity-basicity and the porosity after an evolution time elapses by the diagenesis prediction period. Of course, the actual diagenetic parameter may further include other parameters not listed.

For example, the diagenetic condition parameters may be the mineral content (e.g., content proportions of calcite and dolomite) and the diagenesis prediction period (e.g., three years), and the actual diagenetic parameter may be a measured mineral content of the reservoir after three years (i.e., content proportions of calcite and dolomite after three years).

For another example, the diagenetic condition parameters may also be the mineral content (for example, content proportions of calcite and dolomite), the ion concentration, the temperature and pressure conditions and the diagenesis prediction period (e.g., three years), while the actual diagenetic parameter may be the porosity of the reservoir after three years (or other parameters that cannot be collected or are difficult for collection in actual geologies).

That is, the actual diagenetic parameter and the diagenetic condition parameters may be of the same class or different classes. Therefore, different diagenetic parameter prediction models for the prediction of the diagenetic parameters in different application scenarios can be obtained by being trained with different diagenesis samples, so the application range is wide.

It should be noted that the diagenesis prediction periods in the diagenetic condition parameters of a plurality of diagenesis samples used in the same diagenetic parameter prediction scenario should be the same. That is, when the diagenetic condition parameters in the plurality of diagenesis samples are the mineral content and the diagenesis prediction period of three years, the actual diagenetic parameter for prediction is the mineral content of the reservoir after three years, and when the diagenetic condition parameters are the mineral content and the diagenesis prediction period of one year, the actual diagenetic parameter for prediction is the mineral content of the reservoir after one year, so the different diagenesis prediction periods correspond to two specific diagenetic parameter prediction scenarios.

In the above two examples, the diagenetic condition parameters except the diagenesis prediction period are the measured values obtained at one observation moment (i.e., before the diagenesis prediction period of three years for the reservoir).

However, the complex process of the actual reservoir evolution cannot be reflected if all the diagenetic condition parameters except the diagenesis prediction period are the measured values obtained at an observation time, and this is inconsistent with the actual diagenetic process, such that the simulation of diagenesis is too linear.

Therefore, in some optional embodiments, the ion concentration, the mineral content, the temperature and pressure conditions, the acidity-basicity and the porosity at least included in the diagenetic condition parameters may also be measured values obtained at a plurality of observation moments. For example, for one diagenesis sample of a reservoir, the ion concentration (as well as the mineral content, the temperature and pressure conditions, the buried depth, etc.) of the reservoir may be measured once at different observation moments within the diagenesis prediction period of three years. It should be noted that the time interval between two adjacent observation moments may be equal or unequal, and when the time interval between any two adjacent observation moments is equal, the sampling is periodic. For example, the ion concentration of the samples in the reservoir are obtained every 100 days within the diagenesis prediction period of three years. Next, the obtained discrete parameters are input to the initial diagenetic parameter prediction model. Therefore, except the diagenesis prediction period, the diagenetic condition parameters of other dimensions may be configured with a plurality of sub-dimensions (the measured value obtained at one observation time corresponds to one sub-dimension).

S120: constructing an initial diagenetic parameter prediction model based on the diagenesis samples and a total dimension of the diagenetic condition parameters.

In the embodiments of the present disclosure, the total dimension of the diagenetic condition parameters is related to the number of the dimensions of the diagenetic condition parameters (denoted as n) and the number of the sub-dimensions of each of the diagenetic condition parameters except the diagenesis prediction period. For example, when the diagenetic condition parameters include the diagenesis prediction period, the mineral content and the ion concentration, and both the mineral content and the ion concentration are measured values obtained at one observation moment, the dimension is 3, the sub-dimension of each of the diagenetic condition parameters except the diagenesis prediction period is 1, and the total dimension is 3. When the diagenetic condition parameters include the diagenesis prediction period, the mineral content and the ion concentration, and both the mineral content and the ion concentration are measured values obtained at a plurality of (e.g., m) observation moments, respectively, the dimension is 3, the sub-dimensions of each of the mineral content and the ion concentration is m, and the total dimension is 2m+1. When the diagenetic condition parameters include the diagenesis prediction period, the mineral content and the ion concentration, and the mineral content is a measured value obtained at one observation moment and the ion concentration is composed of measured values obtained at a plurality of (e.g., m) observation moments, the dimension is 3, the sub-dimension of the mineral content is 1, the sub-dimension of the ion concentration is m, and the total dimension is m+2.

It can be understood that when the ion concentration, the mineral content, the temperature and pressure conditions, the acidity-basicity and the porosity in the diagenetic condition parameters are measured values obtained at a plurality of observation moments, the total dimension is increased as compared with the case where the ion concentration, the mineral content, the temperature and pressure conditions, the acidity-basicity and the porosity in the diagenetic condition parameters are measured values obtained at one observation moment, which is helpful to improve the richness of the diagenesis samples, thereby being beneficial to improving the accuracy of the trained diagenetic parameter prediction model and improving the accuracy of the diagenetic parameters obtained by the subsequent prediction using the model.

S130: training the initial diagenetic parameter prediction model with the diagenesis samples until a loss between diagenetic parameter predict values obtained by the initial diagenetic parameter prediction model and the actual diagenetic parameters is within a preset loss range or the diagenetic parameter predict values reach a preset accuracy, so as to obtain a trained diagenetic parameter prediction model.

In this embodiment, the preset accuracy may be set as 90%, 95%, etc., and the accuracy of the diagenetic parameter predict values may be calculated by testing with the test set.

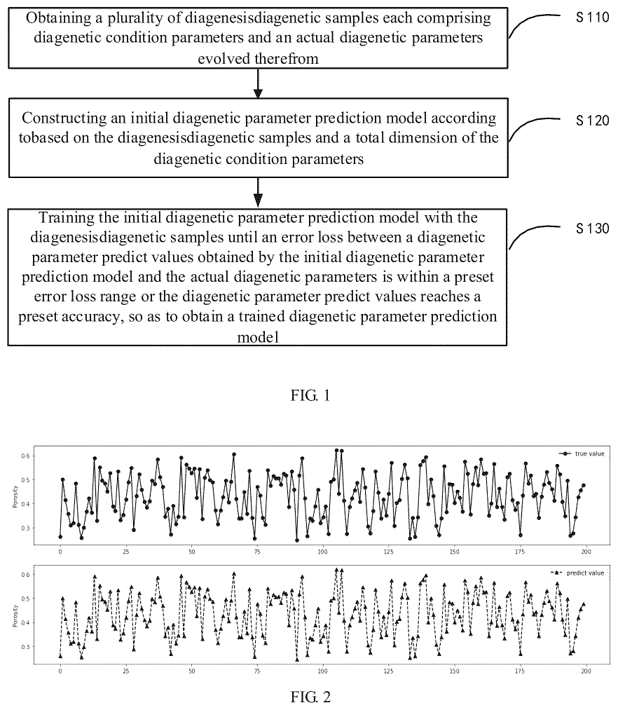

As illustrated in FIG. 2, which is a schematic diagram of a comparison between diagenetic parameter predict values and actual diagenetic parameters. Specifically, the ordinate denotes a porosity and the abscissa denotes a sample number, i.e., there are totally 200 diagenesis samples, each including diagenetic condition parameters and the actual diagenetic parameter, so there are totally 200 actual diagenetic parameters (i.e., corresponding to an upper half of FIG. 2, and the true value is the actual diagenetic parameter corresponding to each of the sample numbers).

The diagenetic condition parameters of each of the diagenesis samples are input into the initial diagenetic parameter prediction model, which outputs the corresponding diagenetic parameter predict values, that is, there are totally 200 diagenetic parameter predict values (i.e., corresponding to a lower half of FIG. 2, and the predict value is the diagenetic parameter predict value corresponding to each of the sample numbers).

When the loss between the diagenetic parameter predict values and the actual diagenetic parameters is less than a preset loss range or when the diagenetic parameter predict values reach a preset accuracy, the training of the initial diagenetic parameter prediction model is finished, and the model obtained after training is a diagenetic parameter prediction model. By the loss calculation for the 200 groups of actual diagenetic parameters and the corresponding diagenetic parameter predict values, it can be determined whether the initial diagenetic parameter prediction model is trained successfully.

The diagenetic parameter prediction model training method based on the artificial intelligence algorithm according to the embodiments of the present disclosure can obtain a diagenetic parameter prediction model by training with the existing diagenesis samples, and apply the diagenetic parameter prediction model to various prediction scenarios, such as a prediction of current data of one or more parameters according to historical data thereof, and a prediction of parameters difficult to obtain in actual geologies according to historical data of one or more other parameters, thereby solving the problem that the diagenetic time of the reservoirs is up to millions of years and there are many influencing factors, resulting in large amount of calculation, high uncertainty and large errors of in the simulation and prediction of the diagenetic parameters, which leads to a low evaluation precision of reservoirs and limits the oil and gas exploration.

Since there may be a large number of the diagenetic condition parameters in the diagenesis samples and parameters unrelated to the actual diagenetic parameters may be existed therein, in order to avoid the curse of dimensionality and reduce the difficulty in subsequently training the initial diagenetic prediction model to obtain the diagenetic parameter prediction model, in the embodiment of the present disclosure, before the step of training the initial diagenetic parameter prediction model with the diagenesis samples in step S130, the method further includes:
carrying out a feature selection on the diagenetic condition parameters, and removing a parameter with an influence coefficient less than a preset value, among the diagenetic condition parameters.

Specifically, the feature selection on the diagenetic condition parameters may be realized in a method such as a filter selection, a wrapper selection or an embedded selection:

A typical example of the filter selection is a Relief method, which is a feature weighting algorithm and implemented as follows:

A diagenesis parameter R is randomly selected from the diagenesis samples, so as to find a nearest neighbor parameter H among parameters of a same class as the parameter R (called as a Near Hit), and find a nearest neighbor parameter M among parameters of a different class from the parameter R (called as a Near Miss).

Next, an initial weight of each parameter is updated according to a following rule: if a distance between the parameter R and the parameter H in a feature is less than a distance between the parameter R and the parameter M in the feature, the feature is beneficial to distinguishing the nearest neighbors of the same class and different classes, and then the weight of the feature is increased. On the contrary, if the distance between the parameter R and the parameter H in a feature is greater than a distance between the parameter R and the parameter M in the feature, the feature plays a negative role in distinguishing the nearest neighbors of the same class and different classes, and then the weight of the feature is decreased.

The above process is repeated for many times, and finally an average weight of each feature is obtained. The classification ability of the feature increases as the weight of the feature rises, and vice versa.

The features with their weights lower than a preset value are removed, so as to obtain the diagenetic condition parameters after feature selection.

The method of filter selection filters the initial parameter features in the diagenesis samples by a feature selection process, and subsequently the parameters after filtration is used to train the model.

The wrapper feature selection directly takes the performance of the model to be finally used as an evaluation criterion for a feature subset, without considering the difference between the subsequent models. In other words, the purpose of the wrapper feature selection is to select a tailored feature subset that is the most beneficial to the performance of a given model. The typical method of the wrapper selection is a Las Vegas Wrapper (LVW) method.

The embedded feature selection is to integrate the feature selection process and the model training process, which are optimized in the same optimization process, i.e., the feature selection, such as an L1 regularization or a decision tree learning, is automatically carried out in the model training process.

Through the methods such as the filter selection, the wrapper selection and the embedded selection, irrelevant and redundant parameters with no ability to describe the difference of the actual diagenetic parameters can be eliminated to obtain the optimized diagenetic condition parameters for the model training, thereby avoiding the curse of dimensionality and reducing the difficulty in training the initial diagenetic prediction model.

Further, in the embodiments of the present disclosure, constructing an initial diagenetic parameter prediction model based on the diagenesis samples and a total dimension of the diagenetic condition parameters in step S120 may further include:
constructing a machine learning model based on the diagenesis samples when the total dimension of the diagenetic condition parameters is less than a preset dimension threshold, and taking the machine learning model as the initial diagenetic parameter prediction model; and
constructing a deep learning network model based on the diagenesis samples when the total dimension of the diagenetic condition parameters is greater than or equal to the preset dimension threshold, and taking the deep learning network model as the initial diagenetic parameter prediction model.

The machine learning model is suitable for the prediction when the total dimension of the parameters is small, while the deep learning network model is suitable for the prediction when the total dimension of the parameters is large. Therefore, in the embodiments of the present disclosure, it is possible to select the type of the constructed model according to the number of the dimensions of the diagenetic condition parameters and the number of the sub-dimensions thereof, and finally select an appropriate model, thereby improving the diagenetic prediction effect and reducing the costs of the model construction and the model training.

Further, in the embodiments of the present disclosure, it is possible to construct a machine learning model based on the diagenesis samples using a random forest method or a decision tree method, take the machine learning model as the initial diagenetic parameter prediction model, and converge a loss set up with the diagenetic parameter predict values obtained by the machine learning model and the actual diagenetic parameters, so as to obtain the diagenetic parameter prediction model by training. Of course, in addition to the random forest method and the decision tree method, the machine learning models may also be constructed using methods such as GBDT and XGBoost.

Specifically, the loss function is:

$$Loss = \frac{1}{2 m} {\sum }_{i = 1}^{m} {( {\hat{y}}_{i} - {y}_{i} )}^{2} ;$$

where m denotes the number of the diagenesis samples, ŷᵢ denotes a diagenetic parameter predict value corresponding to an i-th diagenesis sample, and yᵢ denotes an actual diagenetic parameter corresponding to the i-th diagenesis sample.

Taking the random forest method as an example, the process of constructing the initial diagenetic parameter prediction model includes:

Step 1: randomly generating a plurality of independent training sets for diagenesis samples in a bagging method of sampling with replacement.

When the training set for each decision tree classifier is constructed, the same one sample data may occur many times in the same training sample set because the original diagenesis samples are sampled with replacement. In addition, the obtained training sets are of the same size as the original diagenesis sample set. For example, the number of the samples in the original diagenesis sample set is N, and N samples are randomly selected therefrom with replacement to form a new training set.

Step 2: generating a decision tree according to each of the training sets.

In addition, the features in each of the training sets are randomly selected to split the nodes of the decision tree: when each of the samples has M attributes and each of the nodes of the decision tree needs to be split, m attributes (m<M) are randomly selected from the M attributes, and then one attribute is selected from the m attributes as a split attribute of the node by an information gain strategy or the like.

The above process is repeated until the splitting cannot be continued (i.e., if the attribute selected for the node is the split attribute of a parent node being split and the node has reached the level of leaf node, the splitting cannot be continued), so as to obtain the decision tree.

Step 3: constructing a random forest according to the steps 1 and 2.

Further, in the embodiment of the present disclosure, when the deep learning network model is constructed according to the diagenesis samples and then taken as the initial diagenetic parameter prediction model, the method further includes using a dropout method to partially discard the features learned from a previous hidden layer after an appropriate hidden layer to prevent over-fitting of the model in the training. And a non-linear transformation of the data is performed using an activation function at the hidden layer, and obtaining a final prediction result from the output of a last hidden layer of the model through the activation function; and using an optimization algorithm to adjust the network weight in the training process of the model to converge a loss set up with the diagenetic parameter predict values obtained by the deep learning network model and the actual diagenetic parameters, thereby obtaining the diagenetic parameter prediction model by training.

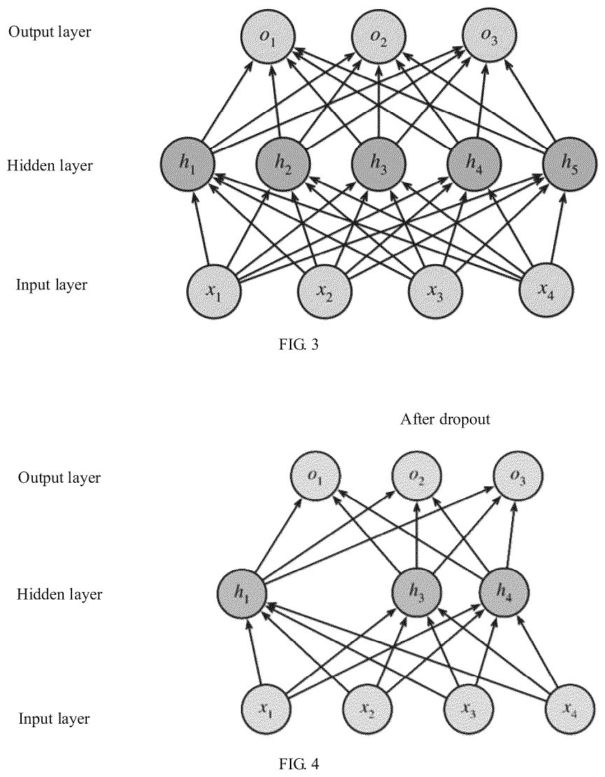

The deep learning network model constructed in the embodiments of the present disclosure includes an input layer, at least one hidden layer and an output layer. For example, the constructed deep learning network model may be as illustrated in FIG. 3, the input layer includes four nodes (i.e., the dimension of the input diagenetic condition parameters is four, and the input parameters for example may be the ion concentration, the mineral content, the temperature and pressure conditions and the diagenesis prediction period), the output layer includes three nodes (i.e., the dimension of the actual diagenetic parameters obtained by prediction is three, and for example, the ion concentration, the mineral content and the porosity are output after the diagenesis prediction period is expired), and the hidden layer is disposed as one layer including five neurons.

In the dropout method, a probability p is given, for example p=40%, then 40% of neurons in the hidden layer are deleted, and only 60% of neurons are left, as illustrated in FIG. 4. For the deep learning network model, the essence is to assign the weight of the 40% of neurons to be 0, and the affection of the neurons assigned to be 0 on the next layer (the output layer) is 0. Then the original hidden layer is expressed with the remaining neurons.

By the above method, it is easy to adjust the complexity of the deep learning network model, and avoid the problem of over-fitting. Meanwhile, the reduction of the number of neurons in the hidden layer will not affect the whole deep learning network model.

Further, in the embodiments of the present disclosure, before the step of training the initial diagenetic parameter prediction model with the diagenesis samples in step S130, the method further includes:
classifying the diagenesis samples into a training set and a test set using a random sampling method or a stratified sampling method.

The random sampling method is suitable for the situations of large-volume data sets and even distribution of target values. For example, when a binary classification model is trained to handle the classification task, if the training data set contains a large number of positive samples and a few negative samples (e.g., the negative samples only account for 10% of the volume of the data set), labels of the positive and negative samples are unevenly distributed. If the random sampling method is adopted at this time, there may be an extreme case where all of the positive samples are classified into the training set and all of the negative samples are classified into the test set, such that the trained binary classification model is not sure to work too well. Therefore, at this time, the stratified sampling method should be used to classify the samples into the data sets, so as to ensure that the training set contains both the positive samples in a certain proportion and the negative samples in a certain proportion.

In some feasible embodiments, 80% of the sample parameters may be taken as the training set and 20% thereof may be taken as the test set, so as to prevent a data snooping deviation, avoid acquiring too much about the characteristics of the samples in the test set, and prevent selecting models beneficial to the data of the test set.

The diagenetic condition parameters in the training set are normalized using a following formula:

$${x}_{i}^{′} = \frac{{x}_{i} - {μ}_{i}}{{δ}_{i}} ;$$

where xᵢ denotes a diagenetic condition parameter of an i-th dimension in the training set, xᵢ′ denotes a normalized value of xᵢ, a value range of i is 1 to n, and n is a dimension of the diagenetic condition parameters; μᵢ denotes an average value of the diagenetic condition parameters in the i-th dimension and δᵢ denotes a standard deviation of the diagenetic condition parameters in the i-th dimension.

It should be noted that when the diagenetic condition parameters except the diagenesis prediction period include more than one sub-dimension, an average value and a standard deviation of those diagenetic condition parameters may be calculated according to the measured values thereof obtained at all observation moments in a plurality of diagenesis samples, so as to perform a normalization. The normalization can overcome the problem of different physical dimension of the diagenetic parameters in different dimensions.

After the initial diagenetic parameter prediction model is trained with the normalized training set to obtain the trained diagenetic parameter prediction model, of which generalization ability is estimated approximately using the test set.

As illustrated in FIG. 5, which is a schematic diagram of steps of a diagenetic parameter prediction method according to an embodiment of the present disclosure. The method includes:

S510: collecting diagenetic condition parameters.

The diagenetic condition parameters at least include one or combinations of an ion concentration, a mineral content, temperature and pressure conditions, an acidity-basicity, and a porosity, which may be measured values obtained at one or more observation moments.

S520: inputting the diagenetic condition parameters into the diagenetic parameter prediction model to obtain diagenetic parameters predicted based on the diagenetic condition parameters.

For example, the mineral content (specifically, content proportions of calcite and dolomite in the reservoir obtained at a plurality of observation moments, respectively) is input into the trained diagenetic parameter prediction model, so as to predict diagenetic parameters after a preset diagenesis prediction period expires, and the diagenetic parameters may be the mineral content of the reservoir after the diagenesis prediction period expires, or the porosity and other parameters of the reservoir.

After being obtained, the diagenetic parameters evolved from the diagenetic condition parameters may also be used to evaluate the reservoir quality.

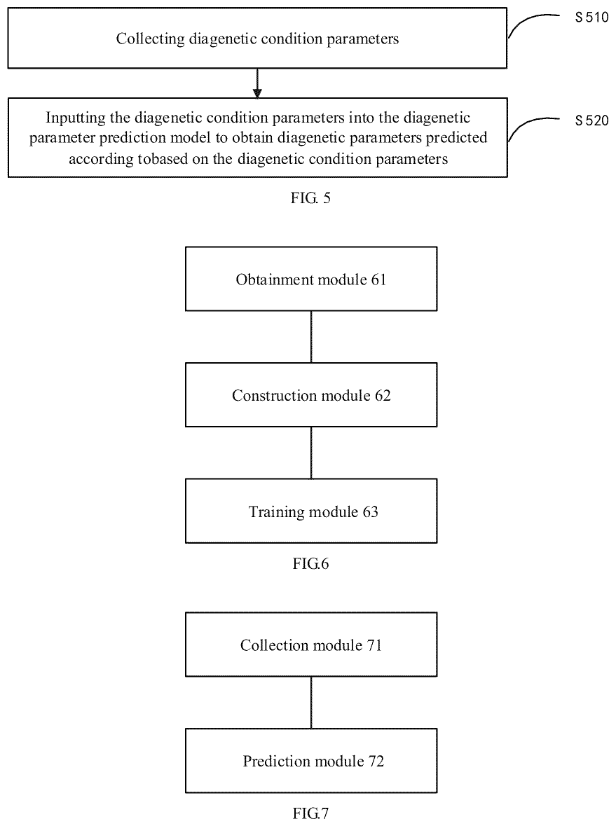

As illustrated in FIG. 6, the present disclosure further provides a diagenetic parameter prediction model training apparatus based on an artificial intelligence algorithm, including:
an obtainment module 61 configured to obtain a plurality of diagenesis samples each comprising diagenetic condition parameters and an actual diagenetic parameter evolved therefrom;
a construction module 62 configured to construct an initial diagenetic parameter prediction model based on the diagenesis samples and a total dimension of the diagenetic condition parameters; and
a training module 63 configured to training the initial diagenetic parameter prediction model with the diagenesis samples until a loss between diagenetic parameter predict values obtained by the initial diagenetic parameter prediction model and the actual diagenetic parameters is within a preset loss range or the diagenetic parameter predict values reach a preset accuracy, so as to obtain a trained diagenetic parameter prediction model.

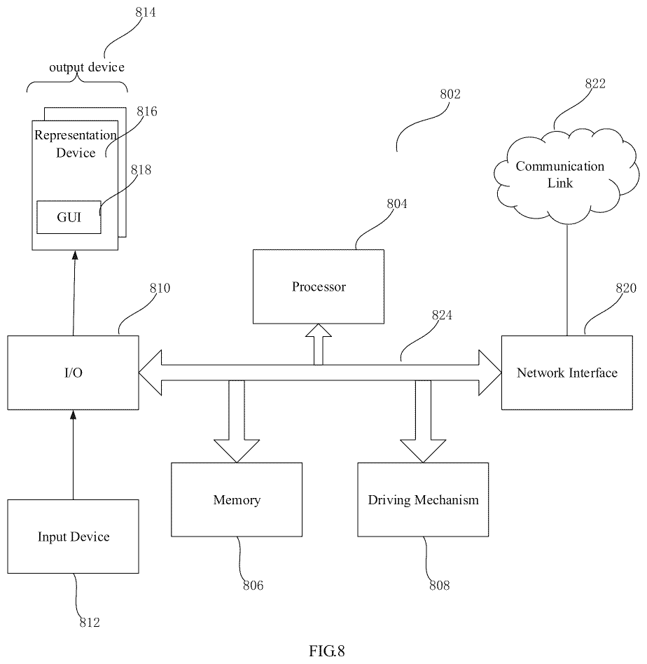

As illustrated in FIG. 7, the present disclosure further provides a diagenetic parameter prediction apparatus, including:
a collection module 71 configured to collect diagenetic condition parameters; and
a prediction module 72 configured to input the diagenetic condition parameters into the diagenetic parameter prediction model to obtain diagenetic parameters predicted based on the diagenetic condition parameters.

The advantageous effects achieved by the apparatus according to the embodiments of the present disclosure are consistent with those achieved by the above method, and will not be repeated here.

As illustrated in FIG. 8, which shows a computer device according to an embodiment of the present disclosure. The computer device may be a diagenetic parameter prediction model training apparatus according to the present disclosure to perform the diagenetic parameter prediction model training method according to the present disclosure. The computer device may further be a diagenetic parameter prediction apparatus to perform the diagenetic parameter prediction method according to the present disclosure. The computer device 802 may include one or more processors 804, such as one or more central processing units (CPUs) each being capable of implementing one or more hardware threads. The computer device 802 may further include any memory 806 for storing any kind of information such as a code, a setting, data, etc. For example, without limitation, the memory 806 may include any one or combinations of any type of RAM, any type of ROM, a flash memory device, a hard disk, an optical disk, etc. More generally, any memory can store information using any technology. Further, any memory can provide a volatile or nonvolatile retention of information. Further, any memory can represent a fixed or removable component of the computer device 802. In one case, when the processor 804 executes associated instructions stored in any one memory or combination of memories, the computer device 802 can perform any one operation of the associated instruction. The computer device 802 further includes one or more driving mechanisms 808, e.g., a hard disk driving mechanism, an optical disk driving mechanism, etc. configured to interacted with any one memory.

The computer device 802 may further include an input/output module 810(I/O) configured to receive various inputs (via an input device 812) and provide various outputs (via an output device 814). A specific output mechanism may include a presentation device 816 and an associated graphical user interface (GUI) 818. In other embodiments, the input/output module 810 (I/O), the input device 812, and the output device 814 may not be included, and the computer device 802 only serves as a computer device in the network. The computer device 802 may further include one or more network interfaces 820 configured to exchange data with other devices via one or more communication links 822. One or more communication buses 824 couple the components described above together.

The communication link 822 may be implemented in any way, for example, by a local area network, a wide area network (e.g., the Internet), a point-to-point connection, etc., or any combination thereof. The communication link 822 may include any combination of a hardwired link, a wireless link, a router, a gateway function, a name server, etc. governed by any protocol or protocol combination.

In correspondence with the methods illustrated in FIGS. 1 and 5, the embodiments of the present disclosure further provide a computer-readable storage medium in which a computer program is stored, and the processor is configured to execute the computer program to implement the steps of the above method.

The embodiments of the present disclosure further provide a computer-readable instruction, and when the instruction is executed by a processor, a program in the instruction enables the processor to perform the methods illustrated in FIGS. 1 and 5.

The embodiments of the present disclosure further provide a computer program product, including at least one instruction or at least one program, and the processor configured to load and execute it to implement the methods illustrated in F1GS. 1 and 5.

It should be understood that in various embodiments of the present disclosure, the sequence numbers of the above processes do not mean an order of execution. The order of execution of the processes should be determined according to the functions and internal logics, and the sequence numbers should not constitute any restriction to implementation processes of the embodiments of the present disclosure.

It should also be understood that in the embodiments of the present disclosure, the term ‘and/or’ is only an association relationship that describes the associated objects, indicating that there may be three relationships. For example, A and/or B may mean that A exists alone, A and B both exist, and B exists alone. In addition, the character ‘/’ in the present disclosure generally indicates that the contextually associated objects are in an ‘or’ relationship.

Those skilled in the art will appreciate that units and algorithm steps of the examples described in conjunction with the embodiments disclosed herein can be implemented by electronic hardware, computer software or a combination thereof. In order to clearly illustrate the interchangeability between hardware and software, compositions and steps of the examples have been generally described in terms of functions in the above description. Whether these functions are implemented by hardware or software depends on the specific applications and the design constraints of the technical solutions. Professionals can use different methods to implement the described functions for each specific application, but such implementation should not be considered as going beyond the scope of the present disclosure.

It will be clearly appreciated by those skilled in the art that for the convenience and conciseness of description, the specific working processes of the systems, apparatuses and units described above can refer to the corresponding processes in the aforementioned method embodiments, which will not be repeated here.

In several embodiments provided herein, it should be understood that the disclosed systems, apparatuses and methods may be implemented in other ways. For example, the apparatus embodiments described above are only schematic. For example, the division of the units is only a logical function division, and in actual implementation, there may be other division ways, e.g., a plurality of units or components may be combined or integrated into another system, or some features may be ignored or not carried out. In addition, the mutual coupling or direct coupling or communication connection illustrated or discussed may be indirect coupling or communication connection through some interfaces, apparatuses or units, and may also be electrical, mechanical or other forms of connections.

The units described as separate components may or may not be physically separated, and the components displayed as the units may or may not be physical units, i.e., they may be located in one place or distributed onto a plurality of network units. Part or all of the units may be selected according to the actual needs to achieve the objective of the technical solutions of the embodiments of the present disclosure.

In addition, the functional units in the embodiments of the present disclosure may be integrated into one processing unit or exist physically alone, or two or more units may be integrated into one unit. The above integrated units may be implemented in the form of hardware or software functional units.

The integrated units may be stored in a computer-readable storage medium when being implemented in the form of software functional units and sold or used as an independent product. Based on this understanding, the essence of the technical solutions of the present disclosure, i.e., the parts that make a contribution to the prior art, or all or part of the technical solutions can be embodied in the form of a computer software product, which is stored in a storage medium and includes several instructions to enable a computer device (which may be a personal computer, a server, a network device, etc.) to perform all or part of the steps of the methods described in the embodiments in the present disclosure. The aforementioned storage medium includes: a U disk, a mobile hard disk, a Read-Only Memory (ROM), a Random Access Memory (RAM), a magnetic disk or an optical disk and any other medium capable of storing program codes.

Specific embodiments are applied in the present disclosure to set forth the principle and the implementations of the present disclosure, and the description of the above embodiments is only used to help the understanding of the method and the core idea of present disclosure. Meanwhile, according to the idea of present disclosure, those of ordinary skill in the art can make changes in the specific embodiments and the application scope. To sum up, the content of the present disclosure should not be construed as limitations to the present disclosure.

What is claimed is:

1. A diagenetic parameter prediction model training method based on an artificial intelligence algorithm, comprising:
obtaining a plurality of diagenesis samples each comprising diagenetic condition parameters and an actual diagenetic parameter evolved therefrom;
constructing an initial diagenetic parameter prediction model based on the diagenesis samples and a total dimension of the diagen.etic condition parameters; and
training the initial diagenetic parameter prediction model with the diagenesis samples until a loss between diagenetic parameter predict values obtained by the initial diagenetic parameter prediction model and the actual diagen.etic parameters is within a preset loss range or the diagenetic parameter predict values reach a preset accuracy, so as to obtain a trained diagenetic parameter prediction model.

2. The method according to claim 1, wherein the diagenetic condition parameters comprise a diagenesis prediction period, and at least further comprise one or combinations of an ion concentration, a mineral content, temperature and pressure conditions, an acidity-basicity, and a porosity; the actual diagenetic parameter at least comprise one or more of the ion concentration, the mineral content, the temperature and pressure conditions, the acidity-basicity and the porosity after an evolution time elapses by the diagenesis prediction period.

3. The method according to claim 2, wherein the ion concentration, the mineral content, the temperature and pressure conditions, the acidity-basicity, and the porosity at least comprised in the diagenetic condition parameters are measured values obtained at one or more observation moments.

4. The method according to claim 3, wherein before the step of training the initial diagenetic parameter prediction model with the diagenesis samples, the method further comprises:
carrying out a feature selection on the diagenetic condition parameters, and removing a parameter with an influence coefficient less than a preset value, among the diagenetic condition parameters.

5. The method according to claim 3, wherein the step of constructing an initial diagenetic parameter prediction model based on the diagenesis samples and a total dimension of the diagenetic condition parameters further comprises:
constructing a machine learning model based on the diagenesis samples when the total dimension of the diagenetic condition parameters is less than a preset dimension threshold, and taking the machine learning model as the initial diagenetic parameter prediction model; and
constructing a deep learning network model based on the diagenesis samples when the total dimension of the diagenetic condition parameters is greater than or equal to the preset dimension threshold, and taking the deep learning network model as the initial diagenetic parameter prediction model.

6. The method according to claim 1, wherein before the step of training the initial diagenetic parameter prediction model with the diagenesis samples, the method further comprises:
classifying the diagenesis samples into a training set and a test set in a preset ratio using a random sampling method or a stratified sampling method; and
normalizing the diagenetic condition parameters in the training set using a following formula:
$${x}_{i}^{′} = \frac{{x}_{i} - {μ}_{i}}{{δ}_{i}} ;$$
where xᵢ denotes a diagenetic condition parameter of an i-th dimension in the training set, xᵢ′ denotes a normalized value of xᵢ, a value range of i is 1 to n, and n is a dimension of the diagenetic condition parameters; μᵢ denotes an average value of the diagenetic condition parameters in the i-th dimension and δᵢ denotes a standard deviation of the diagenetic condition parameters in the i-th dimension.

7. A diagenetic parameter prediction method, which applies a diagenetic parameter prediction model obtained using the diagenetic parameter prediction model training method based on the artificial intelligence algorithm according to claim 1, and the prediction method comprises:
collecting diagenetic condition parameters; and
inputting the diagenetic condition parameters into the diagenetic parameter prediction model to obtain diagenetic parameters predicted based on the diagenetic condition parameters.

8. A diagenetic parameter prediction model training apparatus based on an artificial intelligence algorithm, comprising:
an obtainment module configured to obtain a plurality of diagenesis samples each comprising diagenetic condition parameters and an actual diagenetic parameter evolved therefrom;
a construction module configured to construct an initial diagenetic parameter prediction model based on the diagenesis samples and a total dimension of the diagenetic condition parameters, and
a training module configured to train the initial diagenetic parameter prediction model with the diagenesis samples until a loss between diagenetic parameter predict values obtained by the initial diagenetic parameter prediction model and the actual diagenetic parameters is within a preset loss range or the diagenetic parameter predict values reach a preset accuracy, so as to obtain a trained diagenetic parameter prediction model.
